(19) United States
(12) Patent Application Publication
(10) Pub. No.: US 2009/0146522 A1
(43) Pub. Date: Jun. 11, 2009

(54) Electric servomotor

(76) Inventors: Helmut Knoedler, Lorch (DE); Wilfried Leutner, Schwaebisch Gmuend (DE); Joerg Mayer, Lorch (DE); Michael Ochs, Bartholoma (DE); Thomas Kuehnhoefer, Heubach Lautern (DE); Wolfgang Runge, Ravensburg (DE)

Correspondence Address: JORDAN AND HAMBURG LLP, 122 EAST 42ND STREET, SUITE 4000, NEW YORK, NY, 10168, US

(21) Appl. No.: 12/313,352

(22) Filed: Nov. 19, 2008

(30) Foreign Application Priority Data
Dec. 11, 2007 (DE) 10 2007 055 754.1

(51) Int. Cl. H02K 1/06; H02K 7/116

(52) U.S. Cl. 310/179; 310/83

(57) ABSTRACT

An electric servomotor for a power-assisted steering system in a vehicle has a stator laminated core having an outer diameter and an active length. In order to provide an electric servomotor for a power-assisted steering system that has an optimum diameter/length ratio and that covers a steering performance range from compact cars to full-size vehicles using a reasonable change in volume, it is provided that, with a constant outer diameter, the ratio of the outer diameter to the active length of the stator laminated core can be varied such that the electric servomotor can be used for power-assisted steering systems for compact cars up to full-size cars and the outer diameter is constant.

### BACKGROUND OF THE INVENTION

The invention relates to an electric servomotor for a power-assisted steering system in a vehicle and having a stator laminated core.

Power-assisted steering units for motor vehicles that in particular are embodied as rack-and-pinion steering systems are known. An actuator made of a servomotor and a downstream gear train provides power assistance on a steering gear.

The power assistance can be produced in a variety of ways and can be input into the steering gear in a variety of ways. Thus US 2005/01 727 44 A1 describes an electric rack-and-pinion power-assisted steering unit in which the one electric servomotor, using a worm on its shaft, drives a worm wheel that itself is connected rotation-fast to a steering shaft. The steering shaft inputs a steering force from a driver of a motor vehicle and inputs the power assistance.

DE 103 10 492 A1 describes a power-assisted steering unit in which power assistance is applied to a recirculating ball nut and a spindle segment of the rack from an electric servomotor via a flexible drive. The servomotor is arranged parallel to the rack and is provided for use in a vehicle of defined size. Adapting the power of the electric servomotor to a different vehicle size requires that the housing of the electric servomotor be completely reconstructed.

### SUMMARY OF THE INVENTION

An underlying object of the invention is to provide an electric servomotor for a power-assisted steering system that has an optimum diameter/length ratio and that covers a steering performance range from compact car to full-size vehicle using a reasonable change in volume.

Because the electric servomotor is dimensioned such that, with a constant outer diameter, the ratio of outer diameter to the active length of the stator laminated core is varied, that is, only the length of the stator laminated core is changed, an electric servomotor is created that is suitable for power-assisted steering systems for compact cars up to full-size cars and its housing or housing cover only has to be lengthened in order to adapt the power of the electric servomotor.

In one particularly preferred exemplary embodiment, the ratio of outer diameter to active length of the stator laminated core is about 3.0 to 1.0 and in particular is 2.175 to 1.243. The electric servomotor can be employed together with different types of gear trains for the drive of different steering gears. Thus an output member of the electric servomotor can be a pinion or pulley or worm.

The electric servomotor can be embodied as a hollow shaft motor. It preferably has 400 to 1000 W of power and can be a pulse width-controlled direct current machine.

The invention will now be described in greater detail using an exemplary embodiment and the attached drawings.

### BRIEF DESCRIPTION OF THE DRAWINGS

FIG. 1 is a schematic drawing of an electric power-assisted steering unit.

FIG. 2 shows an inventive electric servomotor.

### DESCRIPTION OF THE PREFERRED EMBODIMENTS

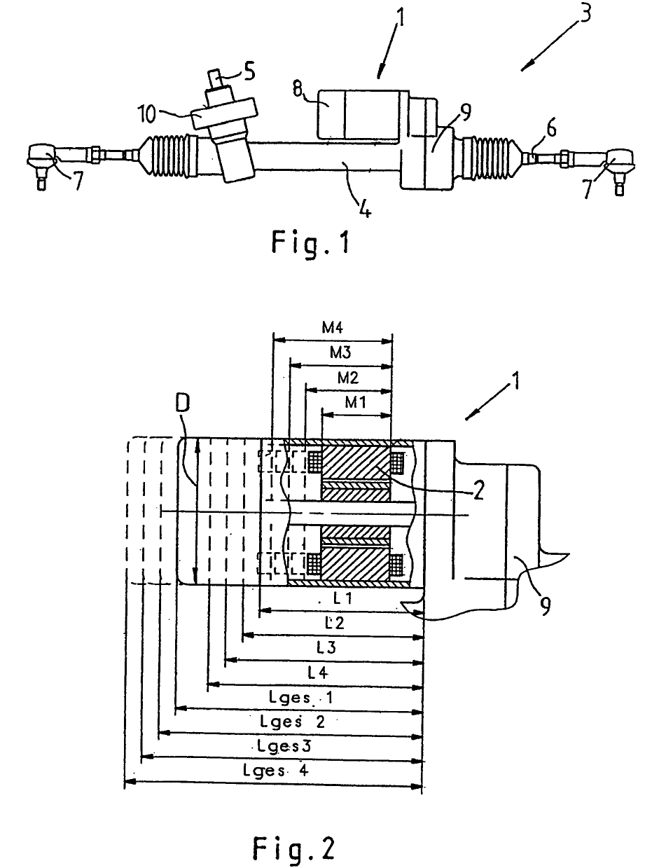

FIG. 1 shows a schematic drawing of an electric rack-and-pinion power-assisted steering unit 3 that largely comprises a cylinder-like steering gear 4 to which a steering shaft 5 is attached that has a steering pinion arranged rotationally fixed thereon. The steering pinion meshes with a toothed segment of a rack 6 that is borne axially displaceable in a steering gear 4 and on the ends of which are arranged tie rod heads 7 for driving wheel linkage levers and for changing the steering angle of steered wheels.

An electric servomotor 1 and an open and/or closed loop unit 8 are connected to a gear train 9, spaced apart from the steering shaft 5. The gear train is embodied as a flexible drive that drives a recirculating ball nut that itself meshes with a spindle segment of the rack. The power assistance is controlled as a function of signals from a torque sensor 10 on the steering shaft 5.

As FIG. 2 illustrates in a partial schematic longitudinal section through the electric servomotor 1, the outer diameter D of the latter is established and constant, while in particular the active length M of its stator laminated core 2 can be increased from M1 to M4. Consequently also the lengths L1 to L4 of the electric servomotor and the associated open and/or closed loop unit 8.

Simply increasing the length of the stator laminated core thus makes it possible to adapt the power of the electric servomotor 1 without significant complexity.

Incorporated herein by reference is German Application DE 10 2007 055 754.1 filed Dec. 11, 2007.

1. An electric servomotor for a power-assisted steering system in a vehicle comprising a stator laminated core having an outer diameter and an active length, with a constant outer diameter, the ratio of the outer diameter to the active length of said stator laminated core being varied such that said electric servomotor can be used for power-assisted steering systems for compact cars up to full-size cars and said outer diameter is constant.

2. An electric servomotor in accordance with claim 1, wherein the ratio of the outer diameter to the active length of said stator laminated core is about 3.0 to 1.0.

3. An electric servomotor in accordance with claim 1, wherein the ratio of the outer diameter to the active length of said stator laminated core is 2.175 to 1.243.

4. An electric servomotor in accordance with any one of claims 1 to 3, wherein an output member of said electric servomotor is a worm.

5. An electric servomotor in accordance with any one of claims 1 to 3, wherein an output member of said electric servomotor is a pinion.

6. An electric servomotor in accordance with any one of claims 1 to 3, wherein an output member of said electric servomotor is a pulley.

7. An electric servomotor in accordance with any one of claims 1 to 3, wherein said electric servomotor is a hollow shaft motor.

8. An electric servomotor in accordance with any one of claims 1 to 3, wherein the power-assisted steering system is a rack-and-pinion power-assisted steering unit.

9. An electric servomotor in accordance with any one of claims 1 to 3, wherein the power of said electric servomotor is about 400 to 1000 W.
